(19) United States
(12) Patent Application Publication
(10) Pub. No.: US 2007/0242666 A1
(43) Pub. Date: Oct. 18, 2007

(54) Apparatus for managing requests for data in a communication network

(75) Inventor: Timothy Alan Barrett, Kanata (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: Alcatel, Paris (FR)

(21) Appl. No.: 11/403,360

(22) Filed: Apr. 13, 2006

(51) Int. Cl. H04L 12/56

(52) U.S. Cl. 370/389

(57) ABSTRACT

An apparatus for managing requests for media data such as video data for effecting rapid channel change in IPTV services comprises an interface for receiving data requests addressed for processing by a particular data request service device, and an agent operatively coupled to the interface and configured for selecting which of a number of different data request service devices to send the request, irrespective of the device to which the request is addressed. The apparatus includes a module for determining if a received request can be serviced by a preferred request service device based on its monitored ability to service the request. If the module determines that the preferred device is capable of servicing the request, the request is directed to that device, and otherwise to another device, which may be the device to which the data request is originally addressed. The preferred request service device may reside at an access node for delivering media services to subscriber equipment.

### FIELD OF THE INVENTION

The present invention relates to apparatus for managing requests for data in communication networks, and in particular, but not limited to apparatus for providing a user device with specific data from a media stream for enabling the device to rapidly start processing the media data.

### BACKGROUND

In existing IP (Internet Protocol) TV broadcast networks, TV channels from one or more service providers are transmitted over the network to various access nodes located in residential or commercial neighborhoods and which provide a connection to each individual subscriber premises to provide selected TV channels and other services to subscriber equipment.

Typically, the transmission media between the access node and the subscriber premises has limited bandwidth and may, for example, comprise a wire line such as a twisted copper pair. Each access node typically receives all of the channels to which customers connected to the access node subscribe. In this case, only one or a few channels may be transmitted from the access node to each subscriber premises at any one time. Therefore, when a subscriber wishes to change to another channel that is not currently being transmitted to the subscriber equipment by the access node, the channel change is performed by the access node, rather than locally at the subscriber equipment.

To reduce the bandwidth required to transport video data, the data is typically compressed prior to transmission by a video compression algorithm such as the MPEG2 standard of the International Telecommunication Unions Moving Pictures Experts Group and the H.264 of the video coding experts group, which compress video into sequences known as groups of pictures (GOPs). Each GOP contains a portion of video data which, when displayed lasts for a fraction of a second to several seconds, and is defined by respective beginning and/or ending boundaries.

Each GOP begins with a reference frame and subsequent video data in the GOP defines successive changes to the reference frame, these changes providing the sequence of video images which are ultimately displayed. A reference frame is typically required by a decoder in order to enable the decoder to start decoding the compressed video data. Therefore, the longer the time interval between successive GOPs, the longer the delay between requesting a video channel and the channel being displayed, and this delay or latency can be quite perceptible.

In order to reduce video display latency when a channel change is effected, special devices may be deployed which are dedicated to providing a portion of a previously transmitted video stream, including a reference frame, to each subscriber's decoder whenever a subscriber requests a channel change. The data is transmitted to each subscriber as a unicast transmission and enables the decoder to begin decoding the video data and displaying the video image in a shorter time than would otherwise be the case if the access node simply connected the decoder directly to the multicast data stream, as this may necessitate a delay before the image can be displayed of up to about the time length of a GOP if the channel change request does not coincide with the transmission of a reference frame in the requested channel. After the requisite portion of unicast video data has been received by the decoder, the access node joins the decoder to the multicast data stream and the video data from the multicast stream is displayed after the unicast video data.

Typically, unicast data sources required for fast channel change are deployed some distance from the access node and a subscriber premises and therefore a significant amount of network resources may be required to carry the unicast data. Furthermore, as a unicast data device provides unicast data to many different subscribers, the network resources may be required to transport a large amount of unicast data. As channel changes may be concentrated at particular times of the day, for example at 30 minute or hourly intervals that coincide with the beginning and ending of programs, the network may be required to carry large amounts of unicast data at the same time, causing a significant burden and possibly even exceeding the network capacity.

### SUMMARY OF THE INVENTION

According to the present invention, there is provided an apparatus comprising an interface for receiving data addressed for processing by and to a predetermined entity, and an agent operatively coupled to the interface and being configured for directing said data to an entity other than said predetermined entity for processing said data.

In this arrangement, an agent intercepts data that is addressed for processing by a predetermined entity and has the ability to redirect the data to another entity for processing the data. This arrangement allows data to be processed by a particular entity without the device from which the data is transmitted needing to specifically address the data to that particular entity. Therefore, redirection of the data by the agent and processing of the data by the other entity can both be transparent to the device from which the data is transmitted. In this arrangement, the agent and the other entity can operate entirely independently of the predetermined entity to which the data is addressed, and therefore operation of the agent and the other entity may be transparent to that predetermined entity. This arrangement also removes the need for the agent to be explicitly identified to any other device, such as the device to which the request is addressed or a system for managing that device or in which the apparatus may operate.

In some embodiments, the agent may be adapted to redirect the data to the other entity and not transmit the data to the predetermined entity.

In some embodiments, the agent is adapted to determine an operation to be performed on the data by the predetermined entity and to select the other entity based on its ability to perform the determined operation.

In some embodiments, the data comprises a request for data to be provided by the predetermined entity. For example, the request for data may comprise a request for media data. Examples of such media data may include a request for a portion of video data to enable a fast channel change to be effected, or a portion of media data that was lost in a previous transmission.

In some embodiments, the apparatus comprises a module for selecting from a plurality of other entities, an entity to which to direct the data.

In some embodiments, the apparatus further comprises a module for determining whether to direct the data to the predetermined entity or to the other entity based on one or more predetermined criteria.

In some embodiments, the predetermined criteria comprises any one or more of (1) the status of the predetermined entity (for example its operational status), (2) the status of the or each other entity (for example its operational status) and (3) where the data comprises a request for data, whether the or each other entity has the requested data.

In some embodiments, the predetermined criteria may comprise any one or more of (1) an egress bandwidth of an entity, (2) an egress capacity of an entity, (3) an ingress capacity of an entity, (4) a processing load of an entity, (5) the number of requests received by an entity, and the load on a network element, e.g. an access node or other node, for example a node where the entity is located.

In some embodiments, the address in the received data comprises a communication network address, for example an IP address, the address of an application (e.g. IP port address) and a media access control (MAC) address.

Also according to the present invention, there is provided an apparatus comprising: a first interface for receiving requests for data from a device; a module for determining if a received request can be serviced by a predetermined request service device; and a second interface for outputting the received request to another request service device if the module determines that the predetermined request service device cannot service the request.

This arrangement provides flexibility in a system which is capable of handling data requests by enabling the device which services the request to be selected from a plurality of different service request devices based on their ability to handle the request. Thus for example, the predetermined request service device may be a preferred request service device for handling data requests, in which case the module may determine that the request is to be handled by that request service device if it is able to do so. However, if the module determines that the preferred request service device is unable to handle the request, the module causes the request to be forwarded to another request service device.

This arrangement may be implemented in a communication network for transporting media data to different subscribers and may be beneficial for implementing fast channel changes to reduce the traffic load on the network. For example, both the predetermined request service device and the other request service device may comprise devices for providing subscriber equipment with video data required for fast channel changes, with the predetermined request service device being situated closer to the subscriber equipment than the other device. For example, the predetermined request service device may be situated at an edge or aggregation node of the network, at an access node connected to individual subscriber premises, or a node between an aggregation node and access node, and the other request service device may be situated more remotely, for example at or near a network edge node, or in the network core. In this case, the module determines whether the predetermined request service device which is closer to the subscriber equipment can handle a received request, and if so, enables that request service device to service the request. If the request service device can handle the request, the data load on the network will be reduced as fewer network resources will be involved in servicing the request due to the proximity of the request service device to the subscriber equipment. On the other hand, the module provides a mechanism by which the request can alternatively be handled by another request service device if the predetermined request service device is unable to service the request, so that the request can still be handled by the system even if the preferred request service device is unable to do so, for example, because that device does not have the requested data, or does not have the capacity (e.g. egress bandwidth) to transmit the required unicast video (or other requested) data. This arrangement also allows the capacity of the predetermined request service device for handling data requests to be limited, and therefore the device to be implemented possibly more simply and at a lower cost.

In some embodiments, the apparatus further comprises a selector for selecting for the determination by the module, requests for data addressed for servicing by a device other than the predetermined request service device. In this embodiment, the selector automatically intercepts data requests addressed to another device so that the module can make a determination of whether the predetermined request service device can service the request. If the module determines that the predetermined request service device can handle the request, it enables that device to do so and may or may not also forward the request to the device to which the request is addressed. Thus, if the predetermined request service device can handle a request, it does so instead of the request service device to which the request is addressed and therefore operates in a manner which is transparent to the requesting device (e.g. subscriber equipment), since there is no need to address the request to the predetermined request service device. Similarly, if the request is forwarded by the module to the device addressed in the request, the intercepting function of the apparatus is transparent to that end device.

In some embodiments, the apparatus further comprises a selector for identifying and selecting requests for data for the determination by the module from other signals received by the first interface. Thus for example, the selector may provide a filtering function for identifying data requests from other signals and may be adapted to pass only data requests to the module to increase the speed at which data requests can be handled.

In some embodiments, the apparatus further comprises a device for including in a data request, an identifier recognizable by the selector that the request is to be processed by the module. For example, a device may be provided for including a label or tag in data requests to assist in identifying those requests for which a determination needs to be made by the module as to whether the request can be handled by one particular data service request device or another.

In some embodiments, the module is adapted to determine if a received request can be serviced by the predetermined request servicing device according to one or more predetermined criteria. The predetermined criteria may include any one or more of (1) that the request cannot be serviced if the requested data is not available at the predetermined request service device, (2) that, even if the data is available at the predetermined request service device, the device cannot service the request based on the status of the device, and (3) that the request cannot be serviced based on a predetermined status of the device. For example, the module may determine that the request cannot be serviced if there is insufficient bandwidth available for transmitting the requested data to the requesting device or that the data request servicing device has a fault, a malfunction or has failed.

In some embodiments, the request for data is a request for video and/or audio data.

In some embodiments, the request is for a portion of data of a data stream carried on a predetermined channel. For example, the portion of data may comprise any one of (a) a portion of data to enable a device to operate, (b) at least a reference frame of a video data stream, (c) one or more identified packets, (d) one or more identified video data packets, (e) video data to enable a device to display an image defined by the video data.

In some embodiments, the request is for data of a channel identified in the request.

In some embodiments, the predetermined request service device comprises a data storage device or storage medium for storing data for servicing data requests. In one embodiment, the data storage device is operatively coupled to one or more sources for supplying one or more data flows, and the data storage device is adapted to temporarily store and then discard successive portions of the or each data flow for servicing data requests.

In some embodiments, the predetermined request service device comprises an interface for transmitting data flow data from the storage device to a device for using the data. Means may also be provided for transmitting the data flow to the user device after requested data from the data storage device has been transmitted by the interface or at any other time (e.g. before or at the same time as the data flow data). For example, the requested data flow data may be transmitted from the storage device to the requesting device by unicast transmission. Subsequently (or at another time) a means such as an interface, transmits a received multicast channel containing the data flow or stream to the requesting device. The multicast stream or data flow may be transmitted to the user device independently of the unicast data or data flow data. In another embodiment, the data flow or stream may be transmitted as a unicast stream, optionally from the storage means.

In some embodiments, the apparatus further comprises a controller for controlling the service request device, the controller causing the device to service the request if the module determines that the device can do so.

In some embodiments, the apparatus further comprises a monitor for monitoring information about the data stored in the data storage device and for providing the information to the module. For example, the data storage device may be operable to store data from a plurality of different channels, and the information identifies the channels for which data is stored in the storage device.

In some embodiments, the apparatus is disposed in a network element, for example an access node or another node.

In some embodiments, the network element has an ingress interface for receiving data from a plurality of channels and an egress interface having a plurality of ports, each for supplying data from a selected channel received at the ingress interface to a device connected to a respective port.

In some embodiments, the network element is adapted to receive IPTV channels from a network and includes means for providing a selected IPTV channel to each of a plurality of subscriber devices, and the predetermined request service device includes a storage device for storing data from at least one channel, and for providing data to a subscriber device from the data storage device in response to a request and the determination made by the module.

According to the present invention, there is further provided an apparatus comprising an interface for receiving requests for data, a selector operatively coupled to the interface for selecting from a plurality of data request service devices, a device for servicing a particular request irrespective of the data request service device identified for servicing the request in the received request.

### BRIEF DESCRIPTION OF THE DRAWINGS

Examples of embodiments of the present invention will now be described with reference to the drawings, in which:

FIG. 1 shows an example of a network for transmitting multicast media data;

FIG. 2 shows a block diagram of an apparatus according to an embodiment of the present invention;

FIG. 3 shows a block diagram of an apparatus according to another embodiment of the present invention;

FIG. 4A shows a flow diagram of a process of determining if a particular data request service device can handle a data request, according to an embodiment of the present invention;

FIG. 4B shows another flow diagram of a process of determining if a particular data request service device can handle a data request, according to an embodiment of the present invention;

FIG. 5 shows a block diagram of an access node according to an embodiment of the present invention;

FIG. 6 shows a block diagram of an access node according to another embodiment of the present invention;

FIG. 7 shows a block diagram of an access node according to another embodiment of the present invention;

FIG. 8 shows a communication network incorporating an embodiment of the present invention;

FIG. 9 shows an example of a communication network incorporating another embodiment of the present invention; and

FIG. 10 shows an example of a communication network incorporating another embodiment of the present invention.

### DESCRIPTION OF EMBODIMENTS

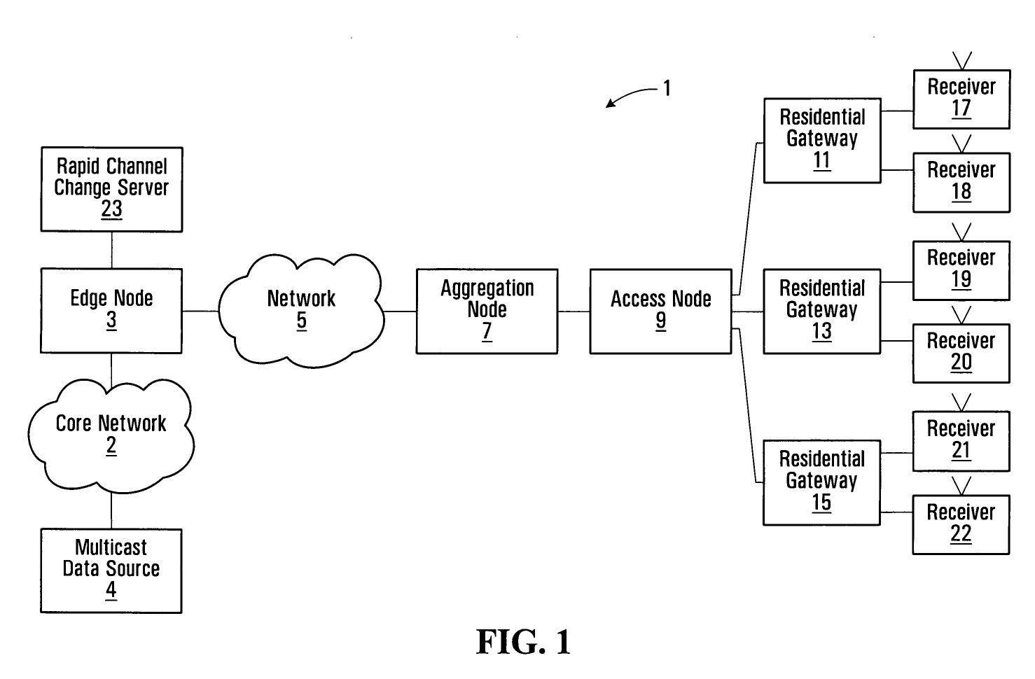

FIG. 1 shows an example of a network for providing IP services to a number of subscribers. The communication network generally shown at 1 comprises a core network 2 servicing edge nodes 3 (only one shown) for providing IP media services from one or more multicast data sources 4 (only one shown), a network 5 connected to the edge node 3, an aggregation node 7, and an access node 9 connected to the aggregation node and for delivering IP services to a number of different subscriber premises. This is an example of an end to end network, and there may be additional layers of physical devices, though FIG. 1 shows the basic functional blocks. In this example, the customer premises equipment (CPE) includes a residential gateway device 11, 13, 15 and one or more receiver(s) 17, 18, 19, 20, 21, 22 which may for example comprise a set top box for a television set, computer or other end user equipment. The access node may comprise, for example, a DSLAM (digital subscriber line access multiplexer) which is connected to subscriber equipment by wire lines and provides xDSL access, some form of fibre to the Node system where the subscriber is connected to the network via optical fiber, or other access technology such as a wireless system (e.g. transceiver). In this conventional communication system, IP media services, such as one or more TV channels are multicast from the edge node over the network to the access node, which replicates the channels and delivers the multicast channels to each subscriber premises.

In an environment providing rapid channel change, when a subscriber requests a channel change, the request is typically unicast from the residential gateway through the network to the edge node to a server 23 which transmits the required portion of the video stream via a unicast signal back to the requesting subscriber equipment to enable a fast channel change. A similar process is performed when the customer premises equipment requests a lost data packet.

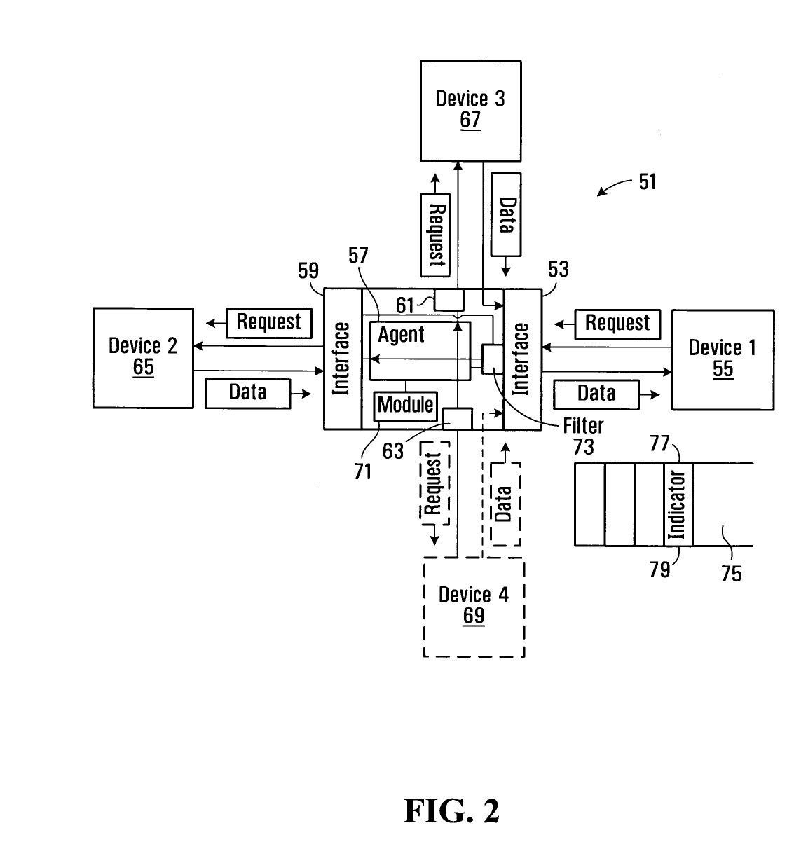

Referring to FIG. 2, an apparatus 51 according to an embodiment of the present invention comprises a first interface 53 for receiving data from a first device 55, and an agent 57 for receiving data from the interface 53. In this example, the apparatus further comprises second, third and fourth interfaces 59, 61, 63 for communication with second, third and fourth devices, respectively.

In one implementation, the agent 53 is configured for directing data received from one device and which is addressed for processing by and to a particular device to another device for processing the data. Thus, in one example, the agent 57 is adapted for receiving data from the first device 55 which is addressed for processing by the second device 65 and directs the data to another device for processing the data, for example, the third or fourth device 67, 69. In other embodiments, the agent may be configured to receive data from any of the second, third or fourth devices addressed for processing by a particular device, and to direct the data to another device to process the data.

In one implementation, the agent may be configured to transmit the data only to one alternative device for processing the data. In other embodiments, the agent 57 may be configured to direct the data both to the device to which the data is addressed and also to one or more other devices for processing. In another implementation, the agent may be configured to redirect the data to a plurality of other devices, and not pass the data to the device to which the data is addressed.

The apparatus may further include a module 71 for determining which device or devices the agent is to direct the data. The module may be adapted to make such a determination based on one or more predetermined criteria.

In some embodiments, the data which the agent is configured to direct to another device are requests for data. In embodiments which include a module for determining which device to transmit data, the module may determine the device to which the data is to be sent based on a device's ability to service the data request.

Embodiments of the apparatus may be implemented in a communication system. For example, in one application, the first device 55 comprises a receiver for receiving media data and may for example be located at a subscriber premises. The apparatus 51 may be located at a network element (or node), for example an access node (or other node) for transmitting the media data to subscriber equipment, including the first device. The second device 65 may comprise a server connected to the second interface 59 for providing media data to subscriber equipment (and may be located at or connected to a node of a communication network). In one embodiment, the server is capable of providing portions of video data to enable subscriber equipment to implement a rapid channel change, and/or to provide lost data packets (e.g. video data packets). The third device 67 and/or the fourth device 69 may comprise a data request service device for servicing data requests from subscriber equipment, for example, requests for video data to enable rapid channel changes and/or lost data packets. Either one or both of the third and fourth devices may be co-located with the apparatus or located more remotely (and connected to the apparatus by a suitable communication link or network). The third and/or fourth device 67, 69 may be located closer to the first device than the second device 65.

In an example of operation, when a subscriber initiates a change from a currently received channel to another channel, the subscriber equipment 55 transmits a request for a portion of the video stream of the requested channel to enable a rapid channel change to be effected, and which is addressed for servicing by the second device 65. The agent 57 intercepts the request and directs the request to one or more devices. The particular device or devices to which the request is directed by the agent may or may not depend on a determination made by the module 71 (if present). Thus, for example, in one embodiment, the agent may be configured to direct data requests addressed to the second device to the third device (and/or fourth device) without taking account of any other factors. The device to which the request is redirected, e.g. the third or fourth device, services the request and transmits the requested data to the subscriber device 55 via the interface 53 (or another interface). In another implementation, the agent is configured to direct data requests to a device based on a determination made by the module. For example, the module may determine whether a particular alternative device to that to which the request is addressed has the requested data or is otherwise able to service the request. For example, the module may determine whether the alternative device has the capacity to service the request. If the module determines that the or each alternative device is unable to service the request, the module may control the agent to direct the request to the device to which the request is originally addressed, for example the second device 65. However, if the module determines that an alternative device, e.g. the third or fourth device, is able to handle the request, the module may control the agent to direct the request to that alternative device. In any implementation, where the agent directs a data request to an alternative device, the agent may be adapted either not to transmit the request also to the device to which the request is addressed or to also transmit the request to the device to which the request is addressed.

The provision of an agent which is configured to intercept data (e.g. data requests) and capable of operating independently (or transparently) of the device to which the data is addressed, removes the need for the agent and/or the device servicing the data/request to be identified or identifiable to the addressed device or to the system, for example to the middleware platform that delivers the requested data, e.g. IPTV rapid channel change data or lost packets.

Referring again to FIG. 2, the apparatus may comprise a filter or selector 73 which is adapted to identify from data received from the first device 55 that data which is to be handled by the agent and to pass that data to the agent, and to cause other data which is not intended for the agent to bypass the agent. This filtering function may assist in increasing the speed and efficiency with which the apparatus can handle data, for example data requests. In one embodiment, data which is intended to be handled by the agent may include a characteristic which assists in identifying the data as data to be handled by the agent. For example, referring to FIG. 2, a data packet 75 transmitted from the first device 55 may include a field 77 for carrying an indicator 79 which indicates that the packet is to be handled by the agent. The filter 73 may be adapted to specifically look for packets which include the indicator and to discriminate between packets which are to be forwarded to the agent and those which are not on this basis. Thus, the filter may provide a means of enabling the apparatus to more rapidly identify data which is to be handled by the agent. Although in FIG. 2, the filter 73 is shown as a separate component, it will be appreciated that in other embodiments, the agent itself may be configured to perform a filtering function, or the filtering function may be performed by another device, for example the interface 53, or by another device.

Embodiments of the apparatus may be used in any other application. For example, the apparatus may be used to monitor traffic in a communication system and to redirect traffic destined for one or more particular entities such as a device or application, to another entity for processing the traffic. For example, the apparatus may provide a security function by monitoring communication signals for malicious traffic and redirecting that traffic to another device to protect the integrity of the network. In another application, the apparatus is adapted to intercept communication data addressed to one or more particular entities and to redirect data for processing by another entity to reduce the load on the entity to which the data is addressed for load balancing, for example.

The agent may be implemented by any suitable means, in hardware, software, or a combination of both. For example, the agent may comprise a processor and computer program running thereon, another programmable or configurable device, an FPGA (Field Programmable Gate Array), a programmable logic device (PLD), a programmable logic array (PLA), or other logic or digital circuit.

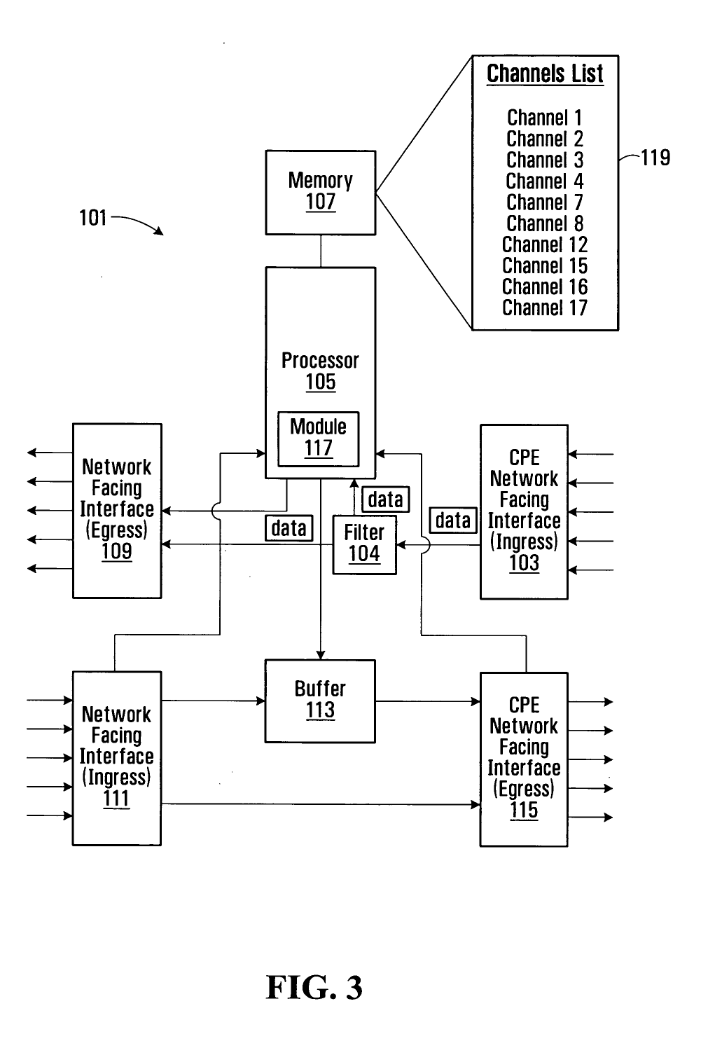

Referring to FIG. 3, an apparatus 101 according to another embodiment of the present invention comprises a first interface 103 for receiving requests for data from a device connected thereto (not shown), an optional filter 104, a processor 105 for processing the received data requests, a memory 107 for storing data used by the processor 105, and a second interface 109 for outputting data requests to another device (not shown). The optional filter 104 may be configured to discriminate between data that is to be passed to the processor, and to forward that data to the processor, and otherwise pass the data to another device, such as the second interface 109.

The apparatus further includes a third interface 111 for receiving both multicast and unicast media data from a network, a buffer 113 for temporarily storing media data from the third interface 111 and a fourth interface 115 for outputting media data to subscriber equipment. In this example, the buffer 113 is adapted to temporarily hold successive portions of media data carried on one or more channels received by the third interface 111 for servicing data requests from subscriber equipment. Requested data may be a portion of a previously transmitted video signal, including for example a video reference frame to enable a fast channel change to be implemented or a request for one or more lost data packets.

The apparatus further comprises a module 117, which in this embodiment is implemented by the processor 105 which performs either one or both of the following two functions: (1) determining if a received request can be serviced by a predetermined request service device, which in this embodiment is the request service device provided by the buffer 113, and forwarding the request to another device via the second interface 109 if it determines that the predetermined request service device is unable to service the request; and (2) intercepting and processing data requests which are addressed to another data request service device.

Examples of various implementations of the apparatus will now be described with reference to FIGS. 2, 3A and 3B.

The buffer 113 may be controlled to store media data from a predetermined number of different channels which may be fewer than the number of channels available to subscribers. The particular channels stored in the buffer may be predetermined and not vary over time, may be varied over time in a predetermined manner, or may be varied dynamically in response to subscriber demand, as for example described in the applicant's co-pending U.S. patent application filed on 12 Apr. 2006, by Timothy A. Barrett, entitled “Device and Method for Dynamically Storing Media Data”, under attorney docket number 195006-00986, which is incorporated herein by reference. For example, the buffer may be controlled only to store media data from those channels which are currently being requested. The buffer may only commence storing a channel when that channel is requested by a subscriber. The processor may monitor the state and residual capacity of the buffer and manage which channels the buffer continues to store and which channels to remove from the buffer when the number of channels requested exceeds the capacity of the buffer. Information identifying the channels for which data is currently stored in the buffer is monitored and a current channels list 119 may be generated and stored in the memory 107, for example. This information can be used by the module 117 to determine whether the buffer 113 can service a particular data request, and whether to forward the data request to another request service device. The channels list can be updated regularly, for example, continually or on a periodic basis.

One or more other parameters or conditions may be monitored and also used by the module 117 in determining whether the data request can be serviced by the local request service device or should be forwarded to another device. Examples of parameters or conditions that may be monitored include the available bandwidth of the egress interface 115 and/or the available bandwidth or capacity of any one or more of the other interfaces 103, 109, 111, the number of data requests received within a predetermined timeframe (e.g. the request pipeline), the status of the local data request servicing device, for example whether the device is operating correctly or whether a malfunction, fault or failure has been detected, the available processing power to service the request(s) and/or the status of another data request service device. In this latter case, if a determination is made that another data request service device (e.g. the device to which the request is addressed) is incapable of handling the request for whatever reason, the module 117 may determine that the request is to be handled by the local device.

In one implementation, only channels that are currently being requested by subscribers may be supplied to the network ingress interface 111. This potentially minimizes the communication network bandwidth used for delivering media data to subscribers. However, in another implementation, the number of channels supplied to the ingress interface 111 may exceed those actually currently requested by subscribers and may comprise some or all channels that are potentially available to subscribers.

As described above, the requests for data received from one or more subscriber(s) may be addressed to a request service device other than the local request service device, for example, a device which is located closer to or at the media data source. The apparatus according to embodiments of the present invention may be adapted to intercept requests that are addressed for servicing by another device, and if the module 117 determines that the request can be serviced by the local device, it may direct the local device to service the request. (However, in other embodiments, requests for data may be specifically addressed to the apparatus, and the apparatus determines which device (e.g. local or remote) is to service the request.) Thus, the local device acts as an agent for the intended request service device and is transparent to the subscriber equipment as there is no requirement to specifically address the agent in the data request or to modify the subscriber equipment to do so. In one implementation, if the module 117 determines that the request can be serviced by the local device, the apparatus may determine not to forward the request to the intended recipient, in which case operation of the agent is also transparent to the data request service device to which the data request is addressed. In another implementation, the apparatus may be configured to forward a data request to the intended request service device even though the module determines that the request can be serviced by the local device. For example, the apparatus may automatically forward a request to the intended recipient in the interest of expediency and subsequently determine that the local device can service the request. In this case, the apparatus may be configured to send a message or signal to the intended request service device to nullify or cancel the data request to prevent the request being serviced by the remote device.

Configuring the apparatus to automatically intercept data requests destined for another device, removes the need for special equipment to coordinate operation between one request service device and another, such as special interfaces for transmitting and receiving control signals, the need for addressing such interfaces and the delay which might result in servicing data requests caused by the need to coordinate operation between the two devices in this manner.

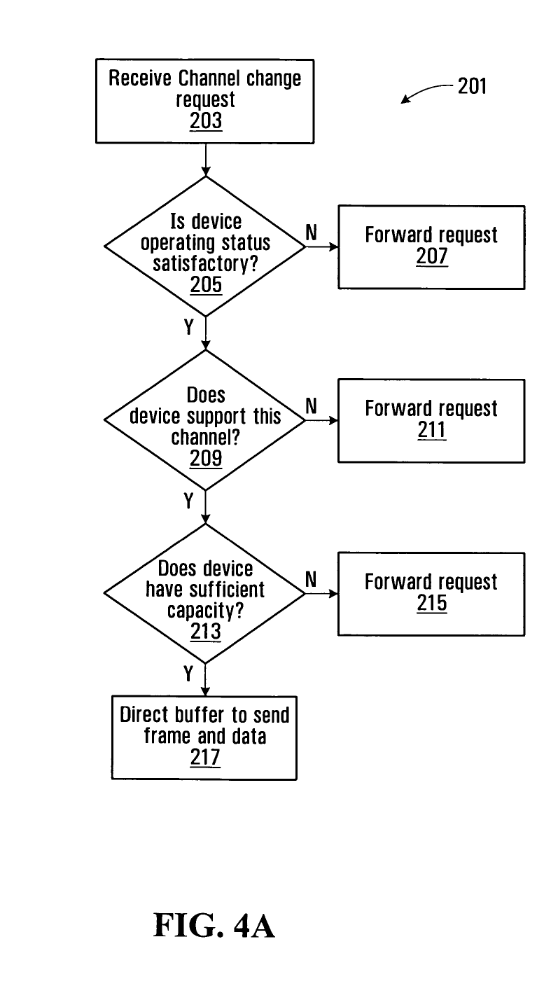

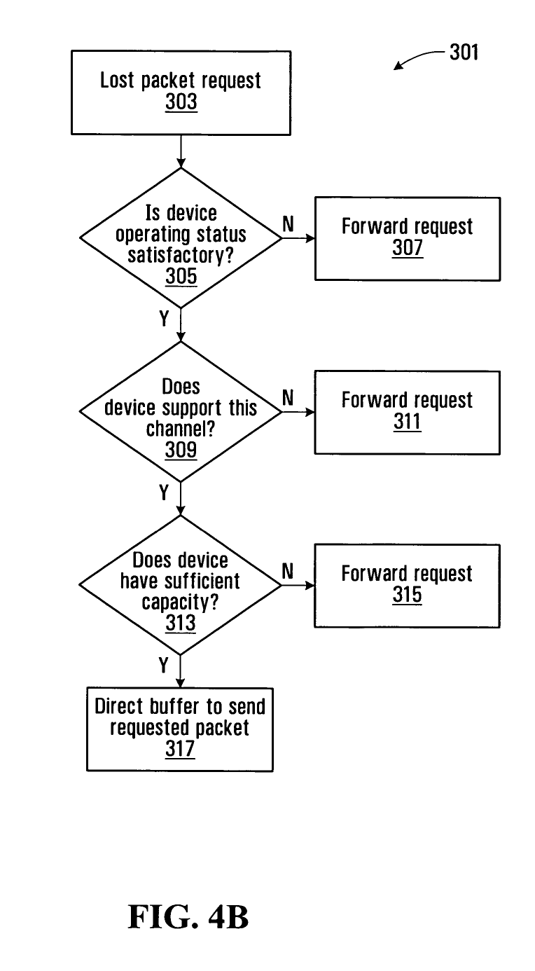

FIG. 4A shows an example of a process illustrating operation of the apparatus when a subscriber requests a channel change. At step 203, a channel change request is received by the apparatus via the interface 103 from a subscriber, and may be addressed to a remote service request device (or directly to the local device). At step 205, the module 117 determines whether the operating status of the local device is satisfactory to be able to service the request. If a determination is made that the operating status is not satisfactory, for example due to a malfunction or failure of the local device, the apparatus determines that the request should be forwarded to another request service device. If the module determines that the local device operating status is satisfactory, the process proceeds to the next inquiry at step 209.

At step 209, the module 117 determines whether the local device supports the requested channel, i.e. whether media data from the requested channel is currently being stored in the buffer 113. This step may be performed by determining whether the channel identified in the request is contained in the current channels list 119. If the channel is not contained in the list (and therefore not stored in the buffer 113), the channel change request is forwarded towards or to another device, e.g. the device to which the request is addressed, or to a secondary pre-configured network device via the second interface 109. If the module 117 determines that the local device does support the channel, the process proceeds to the next inquiry at step 213. At step 213, the module 117 determines whether the local device has sufficient capacity to handle the request. For example, the module may check whether the egress interface 115 has sufficient bandwidth to accommodate a unicast transmission containing the requested media data to the requesting subscriber equipment. This may be achieved by monitoring the available bandwidth and comparing this with the required bandwidth for servicing the request. If the module determines that the local device does not have sufficient capacity, the apparatus will forward the request to another device via the interface 109. On the other hand, if it is determined that the local device does has sufficient capacity, the module directs the local service device to send the requested data, for example, video reference frame and subsequent portions of a GOP to the requesting subscriber equipment.

FIG. 4B shows an example of a process performed by the module 117 for determining whether the local device can service a request for one or more lost data packets. The process is similar to that described above for channel change requests illustrated in FIG. 4A and similar steps are represented by the same reference numerals incremented by 100. The description of the process shown in FIG. 4A applies equally to that shown in FIG. 4B.

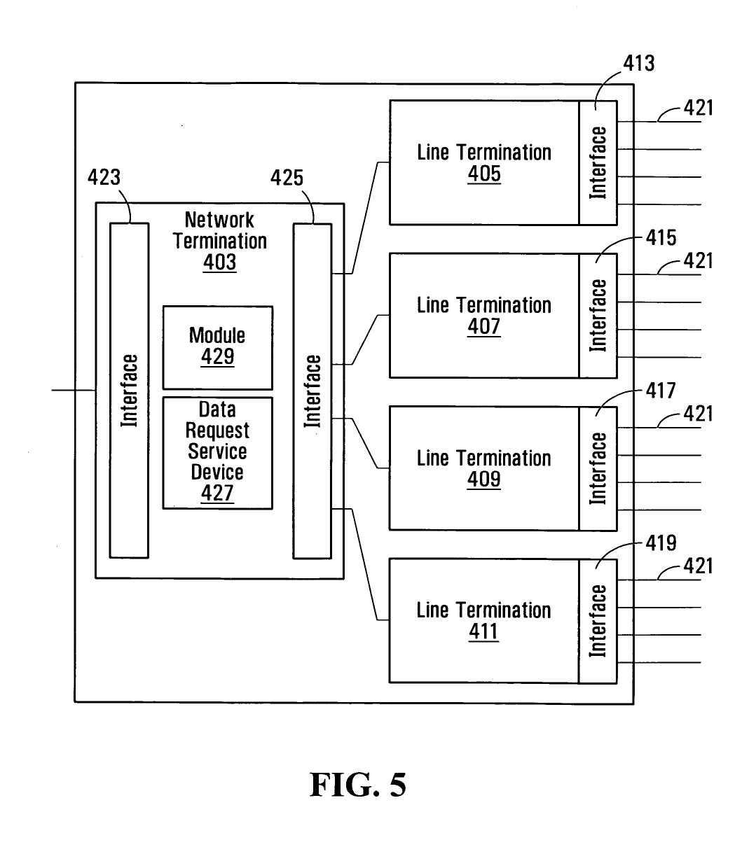

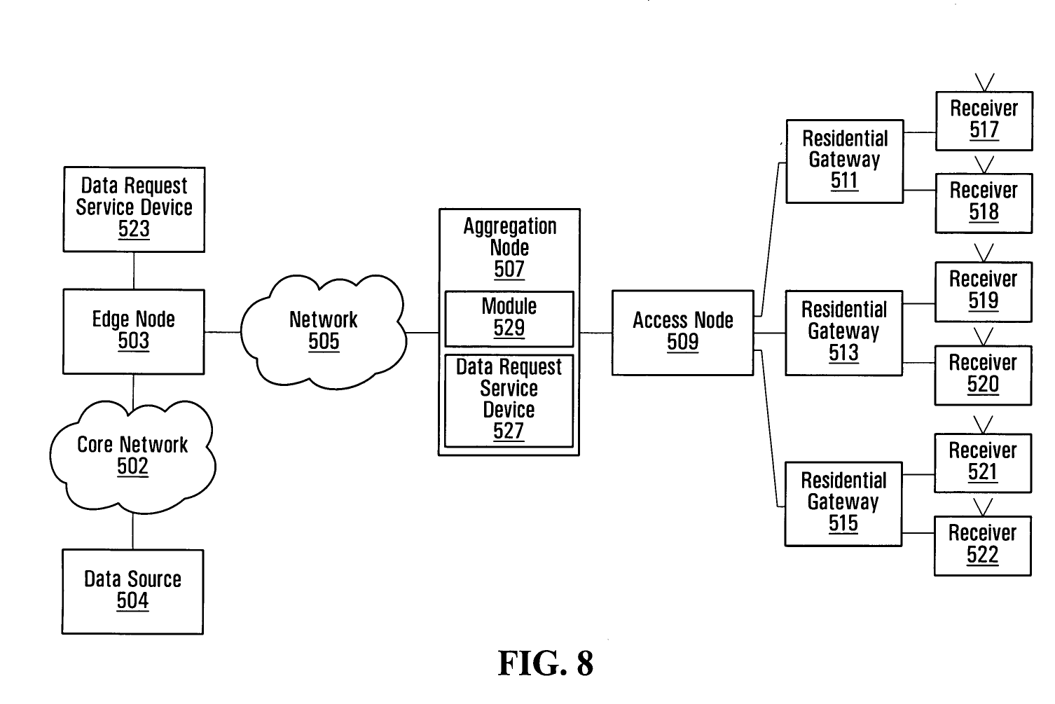

FIGS. 5, 6 and 7 show examples of an access node according to embodiments of the present invention, and FIGS. 8, 9 and 10 show examples of communication networks incorporating embodiments of the present invention.

Referring to FIG. 5, an access node 401 comprises a network termination device 403 and a plurality of line termination devices 405, 407, 409, 411 each having an interface 413, 415, 417, 419 having one or more ports 421 for connection to customer premises equipment. The network termination device has a first interface 423 for transmitting and receiving data to and from a communication network, and a second interface 425 to enable communication between the network termination device and each line termination device 405, 407, 409, 411.

In this embodiment, the network termination device 403 includes a data request service device 427 for servicing data requests received from the interface 425, and a module 429 for intercepting data requests received from the interface 425 and determining whether or not the request is to be serviced by the local device 427 or forwarded to another device, for example a device to which the request is actually addressed. The module and/or data request service device may be implemented and operate in a similar manner to the embodiment thereof described above with reference to FIG. 2 or 3.

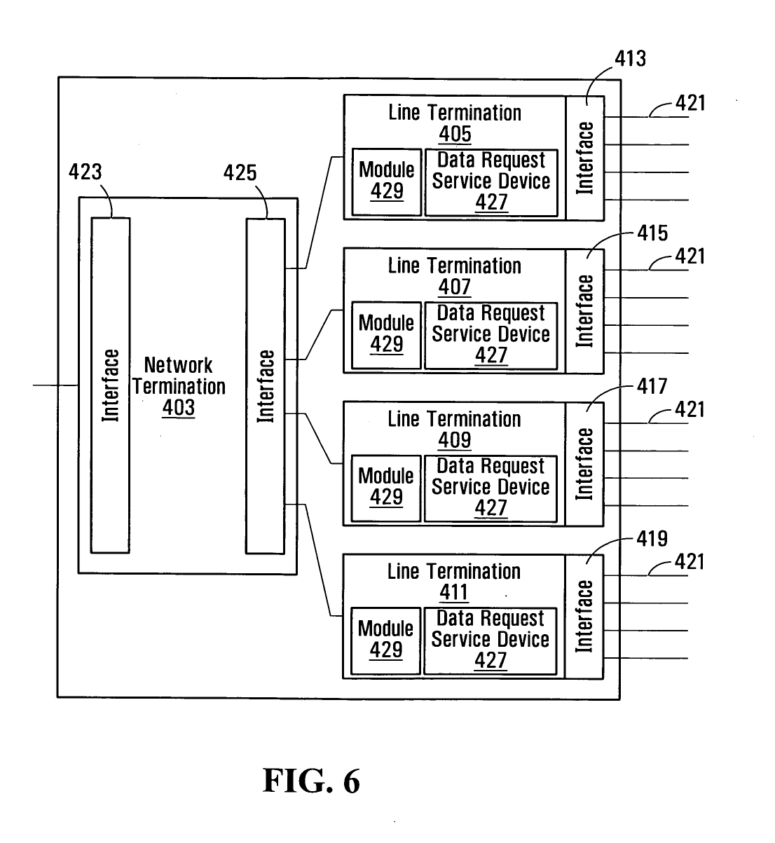

Referring to FIG. 6, another embodiment of an access node comprises a network termination device and a plurality of line termination devices each having an interface, and is similar to that shown in FIG. 5 and like parts are designated by the same reference numerals. However, in the embodiment of FIG. 6, each line termination device comprises a data request service device 427 for servicing data requests from subscriber equipment, and a module 429 for determining whether a respective service device 427 is to service a particular request or whether the request is to be forwarded to another device. Again, one or more service request devices and one or more modules may operate in a similar manner to that described above with reference to FIG. 2 or 3.

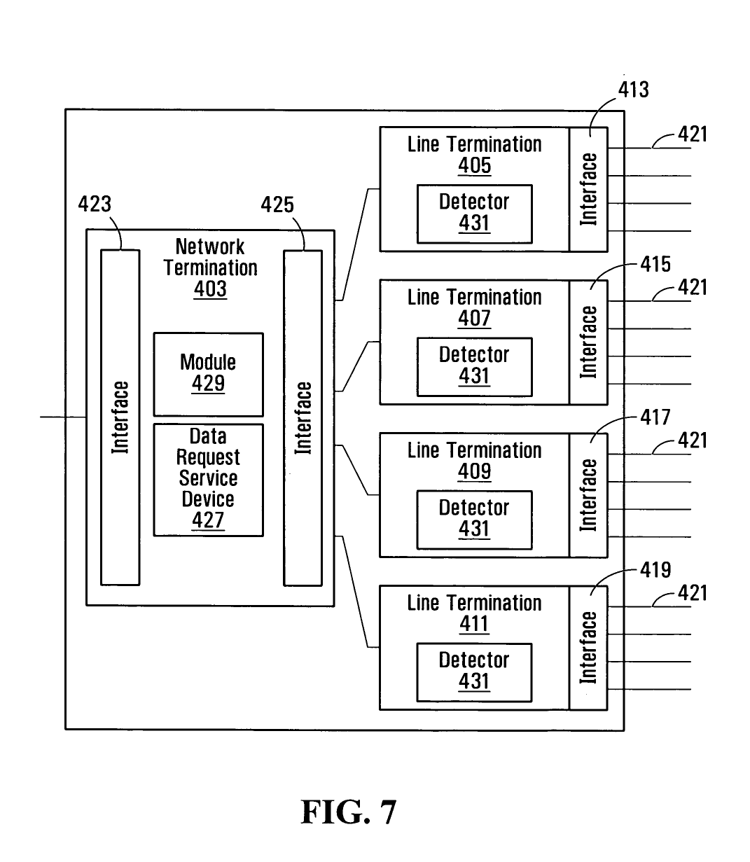

Referring to FIG. 7, another embodiment of an access node comprises a network termination device and a plurality of line termination devices, each having an interface, and is similar to the embodiments of FIGS. 5 and 6, and like parts are designated by the same reference numerals. In this embodiment, the network termination device includes a data request service device 427 and a module 429, and each line termination device includes a detector 431. Each detector is configured specifically for detecting from signals received from subscriber equipment, requests for data, for example, channel change data or lost data packets and for passing the detected requests to the module 429 for further processing. The provision of a detector dedicated to detecting data requests may increase the speed at which the apparatus can make a determination as to whether the request is to be handled by the local request service device 427 or forwarded to another device for processing. For example, the detector may be adapted to perform request detection by looking for one or more specific attributes, artifacts or characteristics which uniquely identify a data request from other types of packets, data or signals received from subscriber equipment. For example, the detector may be adapted to look at a specific portion of a data packet, for example an address, part of an address or another parameter in the packet, or a specific tag or label in the packet which is inserted or added into the packet by subscriber equipment, for example.

In another embodiment, each line termination device may include a module 429 and the data request service device may be situated at the network termination device.

Although FIGS. 5 to 7 show embodiments of the apparatus incorporated into an access node, in other embodiments, the apparatus may be incorporated into any other network element of a communication network, or as a stand alone network device. For example, referring to FIG. 8, the apparatus including a data request service device 429 for servicing data requests and a module for intercepting data requests destined for another request service device and for determining whether the local request service device can service the request are co-located with an aggregation node upstream of the access node.

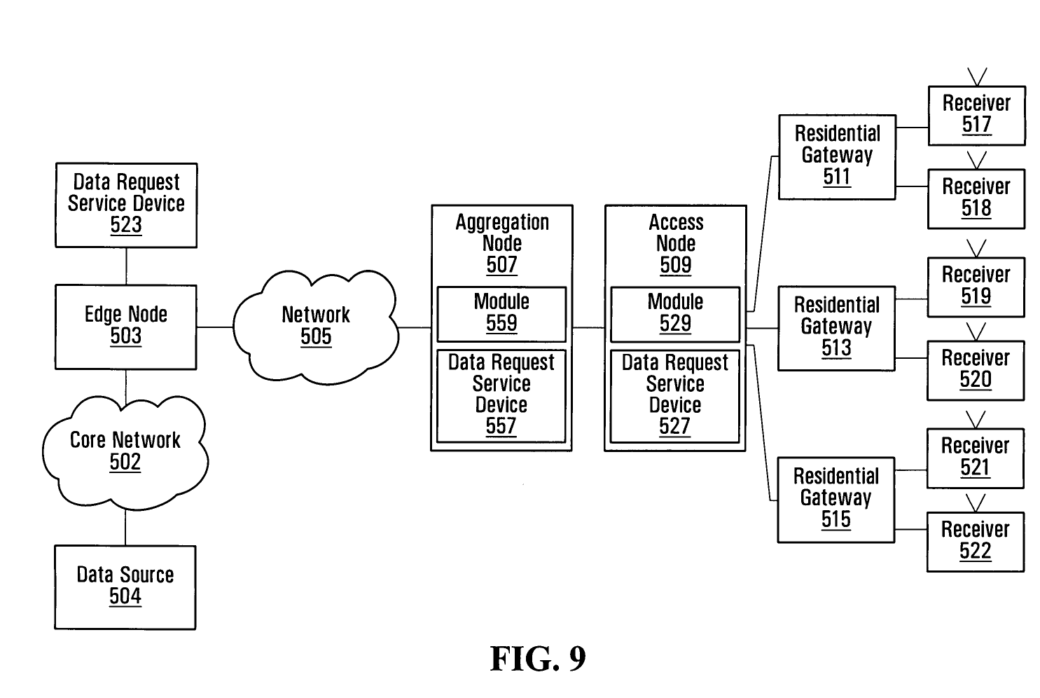

In other embodiments, a plurality of apparatus according to embodiments of the present invention may be incorporated into a plurality of network elements. For example, in the embodiment of FIG. 9, an apparatus comprising a data request service device and a module for determining whether a request can be serviced by the local request service device is incorporated into each of an access node and an aggregation node. Each apparatus may operate in a similar manner to that described above with reference to FIG. 2 or 3, or operate, for example, as a hierarchical pair. For example, if the apparatus at the access node determines that a particular request cannot be serviced by its local service request device, the request may be forwarded from the access node to a second apparatus situated at the aggregation node. The second apparatus may be adapted to intercept the data request (even though it may be addressed to another device such as a request service device near an edge node), and make a similar determination as to whether its local request service device can handle the request. Thus, the second apparatus may provide redundancy for the first apparatus, and vice versa, and each may operate as an agent for the destination request service device to which the request is addressed.

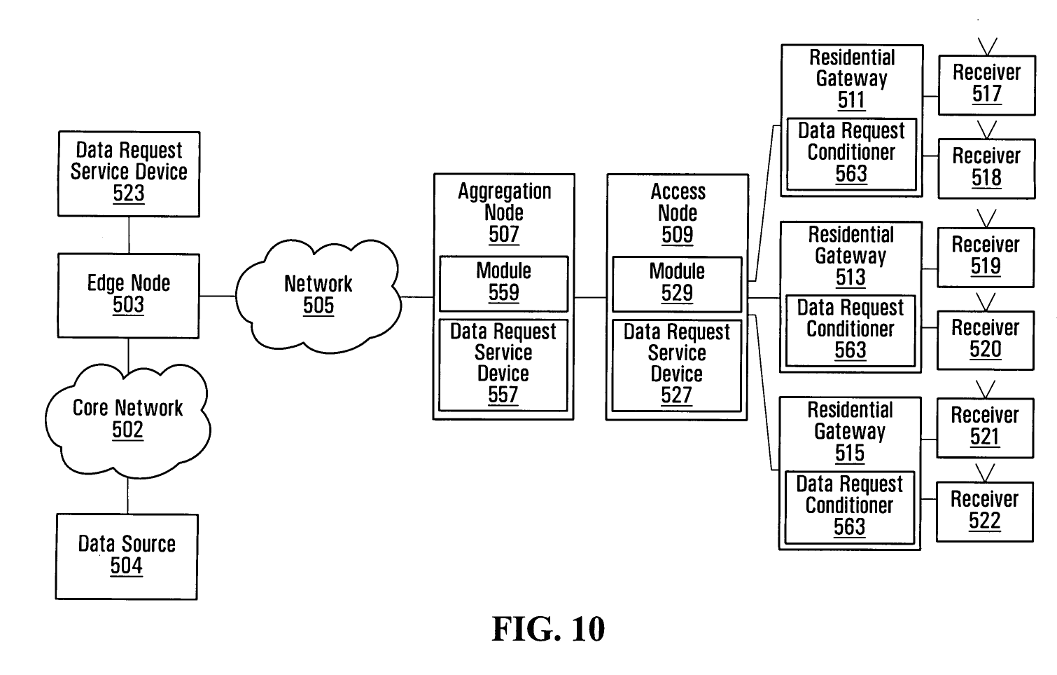

FIG. 10 shows a communication network which is similar in many respects to that shown in FIG. 9, and like parts are designated by the same reference numerals. In this embodiment, each residential gateway includes a data request conditioner for conditioning each data request to facilitate its detection and interception by apparatus according to embodiments of the present invention. For example, the conditioner may insert or add a unique tag, label, artifact or other device to each data request which is recognizable by the apparatus to enable the apparatus to discriminate between data requests and other data or signals transmitted from subscriber equipment to the access node.

Although in FIG. 3 the module is implemented in a processor, in other embodiments, the module may be implemented by any other means in either hardware or software or a combination of both, and may be implemented in a dedicated device, such as an FPGA (field programmable gate array) or ASIC (application specific integrated circuit), programmable logic device (PLD) or programmable logic array (PLA), or by any other means, including a combination of a processor and aforementioned devices.

In other embodiments, any one or more features of the embodiment of FIG. 2 may be combined with any one or more features of the embodiment of FIG. 3, or with any one or more features of any other embodiment disclosed herein.

Other aspects and embodiments of the invention comprise any one or more features disclosed herein in combination with any one or more other features disclosed herein, or an equivalent or variant thereof. In any aspects or embodiments of the present invention, any one or more features disclosed herein may be omitted altogether, or substituted by another feature which may or may not be an equivalent or variant thereof.

Numerous modifications and changes to the embodiments described above will be apparent to those skilled in the art.

1. An apparatus comprising an interface for receiving data addressed for processing by and to a predetermined entity, and an agent operatively coupled to the interface and being configured for directing said data to an entity other than said predetermined entity for processing said data.

2. An apparatus as claimed in claim 1, wherein said agent is adapted to determine an operation to be performed on said data by said predetermined entity and to select said other entity based on its ability to perform said determined operation.

3. An apparatus as claimed in claim 1, wherein said data comprises a request for data from said predetermined entity.

4. An apparatus as claimed in claim 3, wherein said request for data comprises a request for media data.

5. An apparatus as claimed in claim 1, further comprising a module for determining whether to direct said data to said predetermined entity or to said other entity based on one or more predetermined criteria.

6. An apparatus as claimed in claim 5, wherein said predetermined criteria comprises any one or more of (1) the status of said predetermined entity, (2) the status of said other entity, and (3) where the data comprises a request for data, whether the other entity has the requested data.

7. An apparatus as claimed in claim 1, wherein said address comprises a communication network address.

8. An apparatus comprising:
a first interface for receiving requests for data from a device;
a module for determining if a received request can be serviced by a predetermined request service device; and
a second interface for outputting the received request to another request service device if the module determines that the predetermined request service device cannot service the request.

9. An apparatus as claimed in claim 8, further comprising a selector for selecting for said determination by said module, requests for data addressed for servicing by a device other than said predetermined request service device.

10. An apparatus as claimed in claim 8, further comprising a selector for identifying and selecting requests for data for said determination by said module from other signals received by said first interface.

11. An apparatus as claimed in claim 8, wherein said module is adapted to determine if a received request can be serviced by said predetermined request servicing device according to one or more predetermined criteria.

12. An apparatus as claimed in claim 11, wherein said predetermined criteria comprises one or more of (1) that the request cannot be serviced if the requested data is not available at said predetermined request service device, (2) that even if said data is available at said predetermined request service device, the device cannot service the request based on the status of the device, and (3) that the request cannot be serviced based on a predetermined status of the device.

13. An apparatus as claimed in claim 8, wherein the request for data is selected from the group consisting of (i) a request for video data, (ii) a request for a portion of data of a data stream carried on a predetermined channel, and (iii) a request for data of a channel identified in said request.

14. An apparatus as claimed in claim 13, wherein the portion of data comprises any one of (a) a portion of data to enable a device to operate, (b) an amount of video data beginning with a reference frame of a video data stream, (c) one or more identified data packets, (d) one or more identified video data packets, (e) video data to enable a device to display an image defined by said video data.

15. An apparatus as claimed in claim 8, wherein said predetermined request service device comprises a data storage device for storing data for servicing data requests.

16. An apparatus as claimed in claim 15, wherein said data storage device is operatively coupled to one or more sources for supplying one or more data flows, and said data storage device is adapted to temporarily store and then discard successive portions of the or each data flow for servicing data requests.

17. An apparatus as claimed in claim 16, wherein said predetermined request service device comprises an interface for transmitting data flow data from said data storage device to a device for using the data, and means for transmitting said data flow to said user device.

18. An apparatus as claimed in claim 8, further comprising a controller for controlling said service request device, said controller causing said device to service said request if said module determines that said device can service the request.

19. An apparatus as claimed in claim 16, further comprising a monitor for monitoring information about the data stored in said data storage device and for providing the information to said module.

20. An apparatus as claimed in claim 19, wherein said data storage device is operable to store data from a plurality of different channels, and said information identifies the channels for which data is stored in said storage device.

21. An apparatus as claimed in claim 8, further comprising said predetermined data request service device.

22. An apparatus as claimed in claim 8, disposed in a network element, said network element having an ingress interface for receiving data from a plurality of channels and an egress interface having one or more ports, each for supplying data from a selected channel received at said ingress interface to a device connected thereto.

23. An apparatus as claimed in claim 22, wherein said network element is adapted to receive IPTV channels from a network and includes means for providing a selected IPTV channel to each of a plurality of subscriber equipment, and said predetermined request service device includes a storage device for storing data from at least one channel, and for providing data to a subscriber equipment from said data storage device in response to a request and the determination made by said module.

24. An apparatus as claimed in claim 9, further comprising a device for including in a data request, an identifier recognizable by said selector that the request is to be processed by said module.

25. An apparatus comprising an interface for receiving requests for data, a selector operatively coupled to the interface for selecting from a plurality of data request service devices, a device for servicing a particular request irrespective of the data request service device identified in the received request for servicing the request.
